(19) United States
(12) Patent Application Publication
(10) Pub. No.: US 2026/0043285 A1
(43) Pub. Date: Feb. 12, 2026

(54) Reinforced School Door

(71) Applicant: EF-5 Builders Inc., Amarillo, TX (US)

(72) Inventor: Christopher Claybrook, Amarillo, TX (US)

(21) Appl. No.: 18/813,236

(22) Filed: Aug. 23, 2024

Related U.S. Application Data
(60) Provisional application No. 63/679,623, filed on Aug. 6, 2024.

(51) Int. Cl. E05D 15/48

(52) U.S. Cl. CPC E05D 15/48; E05D 2015/485; E05Y 2201/258; E05Y 2900/132

(57) ABSTRACT

A reinforced door assembly for selectively barricading a doorway of a protected room. The reinforced door assembly comprises one or more track assemblies, a door assembly, one or more track wheel assemblies, one or more magnetic receiver assemblies on a stopper assembly, and one or more ferromagnetic plates. The reinforced door assembly is installed on a wall within a protected room, such as a school classroom. The one or more track assemblies is aligned with and partially surrounds the doorway. The door assembly is configured to selectively slide between an open configuration and a closed configuration along the one or more track assemblies. The open configuration comprises the door assembly not blocking the doorway. The closed configuration comprises barricading the doorway with the door assembly. The one or more track assemblies comprises at least an upper track assembly.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant.

### BRIEF SUMMARY OF THE INVENTION

A reinforced door assembly 100 for selectively barricading a doorway 300 of a protected room. Said reinforced door assembly 100 comprises one or more track assemblies 102, a door assembly 104, one or more track wheel assemblies 600, one or more magnetic receiver assemblies 108 on a stopper assembly 110, and one or more ferromagnetic plates 112. Said reinforced door assembly 100 is installed on a wall within a protected room, such as a school classroom. Said one or more track assemblies 102 is aligned with and partially surrounds said doorway 300. Said door assembly 104 is configured to selectively slide between an open configuration 114 and a closed configuration 116 along said one or more track assemblies 102. Said open configuration 114 comprises said door assembly 104 not blocking said doorway 300. Said closed configuration 116 comprises barricading said doorway 300 with said door assembly 104. Said one or more track assemblies 102 comprises at least an upper track assembly 102a. Said door assembly 104 slidably attach to said upper track assembly 102a using said one or more track wheel assemblies 600. Said one or more track wheel assemblies 600 hang down from and selectively slide within said upper track assembly 102a. A top portion 118 of said door assembly 104 attach to said one or more track wheel assemblies 600. With said reinforced door assembly 100 in said closed configuration 116, said one or more magnetic receiver assemblies 108 and said one or more ferromagnetic plates 112 attached to one another. Said one or more magnetic receiver assemblies 108 comprises a 1200-pound magnet, providing a secure hold when the door is in the closed position. Said reinforced door assembly 100 comprises a structural frame 700. Said door assembly 104 is constructed from ⅜-inch thick AR500 steel, chosen for its ballistic resistance properties, providing robust protection against projectiles.

Said reinforced door assembly 100 for selectively barricading said doorway 300 of a protected room. Said reinforced door assembly 100 comprises said one or more track assemblies 102, said door assembly 104, said one or more track wheel assemblies 600, said one or more magnetic receiver assemblies 108 on said stopper assembly 110, and said one or more ferromagnetic plates 112. Said reinforced door assembly 100 is installed on a wall within a protected room, such as a school classroom. Said one or more track assemblies 102 is aligned with and partially surrounds said doorway 300. Said door assembly 104 is configured to selectively slide between said open configuration 114 and said closed configuration 116 along said one or more track assemblies 102. Said open configuration 114 comprises said door assembly 104 not blocking said doorway 300. Said closed configuration 116 comprises barricading said doorway 300 with said door assembly 104.

A method for emergency management using said reinforced door assembly 100 system, the method is disclosed. Comprising initiating on a local application 806 running on one or more processors 802 of said reinforced door assembly 100, the following steps. Initiating a lockdown sequence upon detecting a door closing event 1202, arming said one or more magnetic receiver assemblies 108 to secure said door assembly 104 in said closed configuration 116, starting a timeout clock 1108 to count down to an automatic unlocking of said door assembly 104, overriding upon receiving an override command, said timeout clock 1108 for an extended lockdown period, and concluding the lockdown sequence by unlocking said one or more magnetic receiver assemblies 108 in response to an all-clear signal or the elapsation of said timeout clock 1108. Wherein, said reinforced door assembly 100 comprises said one or more track assemblies 102, said door assembly 104, said one or more track wheel assemblies 600, said one or more magnetic receiver assemblies 108 on said stopper assembly 110, and said one or more ferromagnetic plates 112. Said reinforced door assembly 100 is installed on a wall within a protected room, such as a school classroom. Said one or more track assemblies 102 is aligned with and partially surrounds said doorway 300. Said door assembly 104 is configured to selectively slide between said open configuration 114 and said closed configuration 116 along said one or more track assemblies 102. Said open configuration 114 comprises said door assembly 104 not blocking said doorway 300. Said closed configuration 116 comprises barricading said doorway 300 with said door assembly 104. Said reinforced door assembly 100 further comprises a door control panel 200. Said door control panel 200 is installed behind said door assembly 104 with said door assembly 104 in said open configuration 114. Said reinforced door assembly 100 comprises a door controller assembly 810 having said one or more processors 802, a memory unit 804, said local application 806, and a communication unit 808.

### BRIEF DESCRIPTION OF THE SEVERAL VIEWS OF THE DRAWING

FIG. 1 illustrates a perspective overview of a reinforced door assembly 100.

FIG. 2 illustrates a perspective overview of said reinforced door assembly 100 with a door assembly 104 in a closed configuration 116.

FIG. 3 illustrates a perspective overview of said reinforced door assembly 100 installed around a doorway 300 with a door 302 in an open-door configuration 304.

FIG. 4 illustrates a perspective overview of said reinforced door assembly 100.

FIGS. 5A and 5B illustrate a lower perspective view of said reinforced door assembly 100 showing an upper track assembly 102a and said door assembly 104 in an open configuration 114 and said closed configuration 116, respectively.

FIG. 6 illustrates an elevated overview of said reinforced door assembly 100 with said door assembly 104 detached from one or more track assemblies 102.

FIG. 7 illustrates an exploded elevated overview of said door assembly 104.

FIG. 8 illustrates a components diagram 800 of said reinforced door assembly 100.

FIG. 9 illustrates an overview diagram of said reinforced door assembly 100 used in a network setting.

FIG. 10 illustrates a network diagram 1000 of a server 902 and a plurality of door assemblies 900.

FIG. 11 illustrates a block diagram of a local application 806 integrated within the security enhancement system.

FIG. 12 illustrates a local app flowchart 1200.

FIG. 13 illustrates a server action flowchart 1300 for a server application 1002.

FIGS. 14A and 14B illustrate a perspective overview from a front and rear vantage of said door assembly 104 with a whiteboard insert 1400 being removed.

FIGS. 15A and 15B illustrate an elevated front view of said reinforced door assembly 100 installed around said doorway 300 and in said open configuration 114 and said closed configuration 116, respectively.

FIGS. 16A and 16B illustrate two perspective views of a lower portion 706 and said whiteboard insert 1400.

FIGS. 17A and 17B illustrate two perspective views of said lower portion 706 with one or more lower support wheel assemblies 1604 and a lower track assembly 102b.

FIG. 18 illustrates a flow chart of a method of use 1800 of said reinforced door assembly 100.

FIG. 19 illustrates a perspective overview of said reinforced door assembly 100.

FIGS. 20A and 20B illustrate a perspective frontside and rear side view of said reinforced door assembly 100.

FIG. 21 illustrates a perspective overview of said reinforced door assembly 100 in said closed configuration 116.

FIGS. 22A and 22B illustrate a perspective frontside and rear side view of said reinforced door assembly 100 without said whiteboard insert 1400.

FIG. 23 illustrates a perspective overview of said reinforced door assembly 100 without said whiteboard insert 1400.

FIGS. 24A and 24B illustrate a perspective front view of said reinforced door assembly 100 with a hinged portion 2400 in a lowered configuration 2402.

FIG. 25 illustrates a lower hinge assembly 2500 of said reinforced door assembly 100.

FIG. 26 illustrates a perspective overview of said reinforced door assembly 100 with a detailed view of said one or more lower support wheel assemblies 1604.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

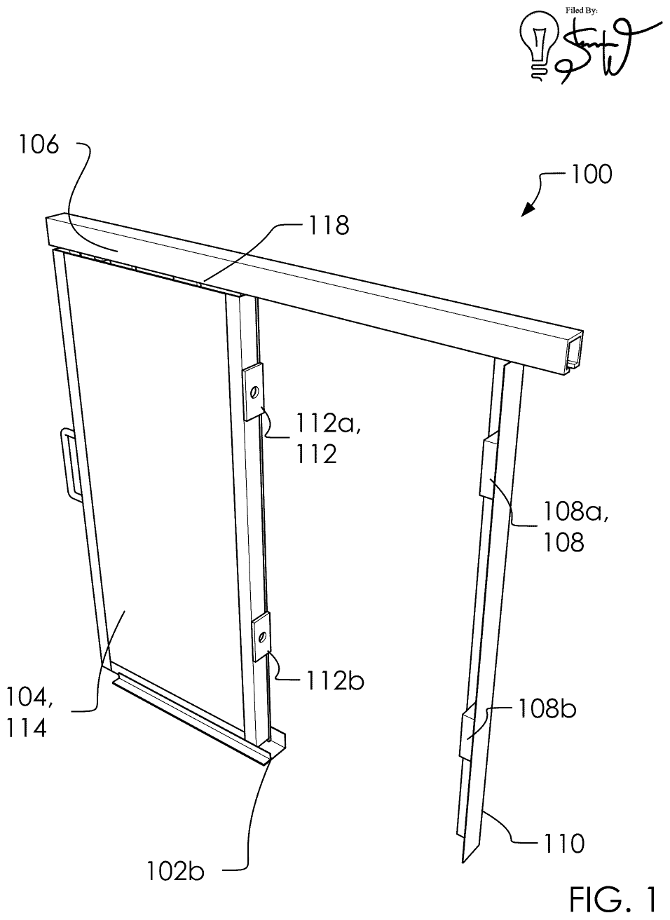

FIG. 1 illustrates a perspective overview of a reinforced door assembly 100.

In one embodiment, said reinforced door assembly 100 can comprise one or more track assemblies 102, a door assembly 104, one or more magnetic receiver assemblies 108 on a stopper assembly 110, and one or more ferromagnetic plates 112.

In one embodiment, said one or more ferromagnetic plates 112 can comprise a first ferromagnetic plate 112a and a second ferromagnetic plate 112b; said one or more magnetic receiver assemblies 108 can comprise a first magnetic receiver assemblies 108a and a second magnetic receiver assemblies 108b; and said one or more track assemblies 102 can comprise an upper track assembly 102a and a lower track assembly 102b.

In one embodiment, said door assembly 104 can selectively slide along said one or more track assemblies 102 between an open configuration 114 (as illustrated) and a closed configuration 116 (illustrated below).

In one embodiment, said one or more track assemblies 102 comprises at least said upper track assembly 102a.

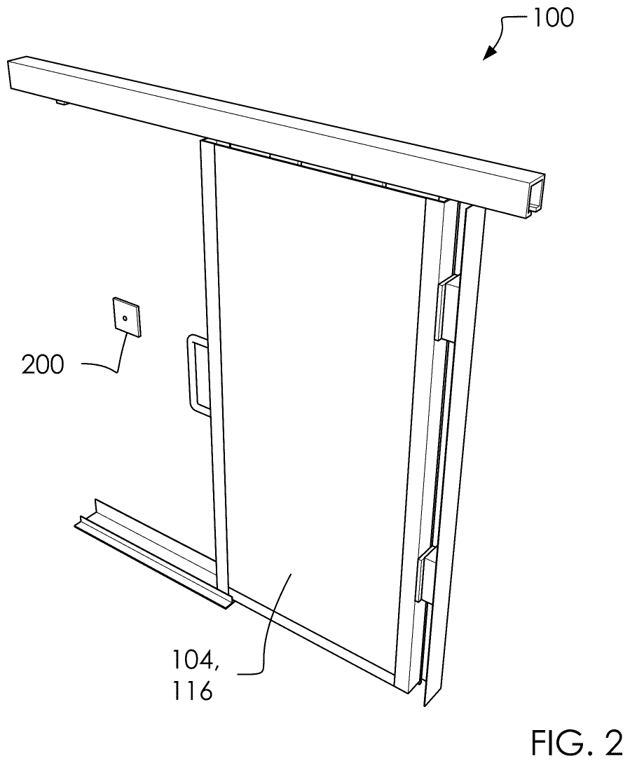

FIG. 2 illustrates a perspective overview of said reinforced door assembly 100 with said door assembly 104 in said closed configuration 116.

As illustrated, with said reinforced door assembly 100 in said closed configuration 116, said one or more magnetic receiver assemblies 108 and said one or more ferromagnetic plates 112 can be attached to one another.

In one embodiment, said reinforced door assembly 100 can further comprise a door control panel 200. In one embodiment, said door control panel 200 can be installed behind said door assembly 104 with said door assembly 104 in said open configuration 114.

Incorporating an electronic controller and a magnetized locking system, said door assembly 104 features advanced security mechanisms that can be interfaced with through various electronic means. Access for law enforcement and authorized personnel can be granted via RFID codes, near-field communication, or other electronic methods. These access points are designed to seamlessly communicate with the door's electronic controller for locking or releasing said door assembly 104, with the capability for integration into cloud services for remote management and monitoring.

The locking system of said door assembly 104 can be centered said one or more magnetic receiver assemblies 108 which can comprise a 1200-pound magnet, providing a secure hold when the door can be in the closed position.

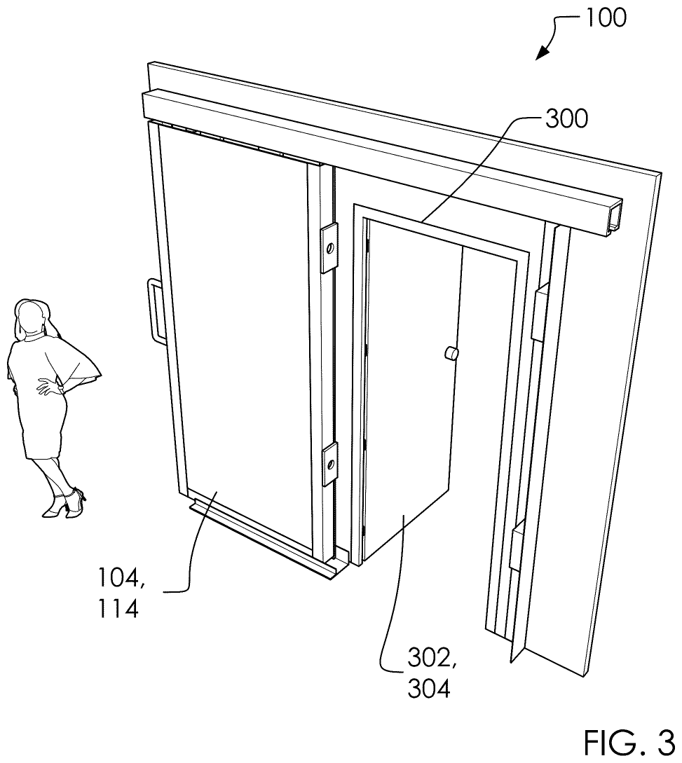

FIG. 3 illustrates a perspective overview of said reinforced door assembly 100 installed around a doorway 300 with a door 302 in an open-door configuration 304.

In one embodiment, said reinforced door assembly 100 can be configured to selectively barricade said doorway 300.

In one embodiment, said reinforced door assembly 100 can be installed on a wall within a protected room, such as a school classroom. Wherein, said one or more track assemblies 102 can be aligned with and partially surround said doorway 300, as illustrated. In one embodiment, said door assembly 104 can slide between said open configuration 114 and said closed configuration 116 along said one or more track assemblies 102, with said door assembly 104 not blocking said doorway 300 in said open configuration 114 and barricading said doorway 300 in said closed configuration 116.

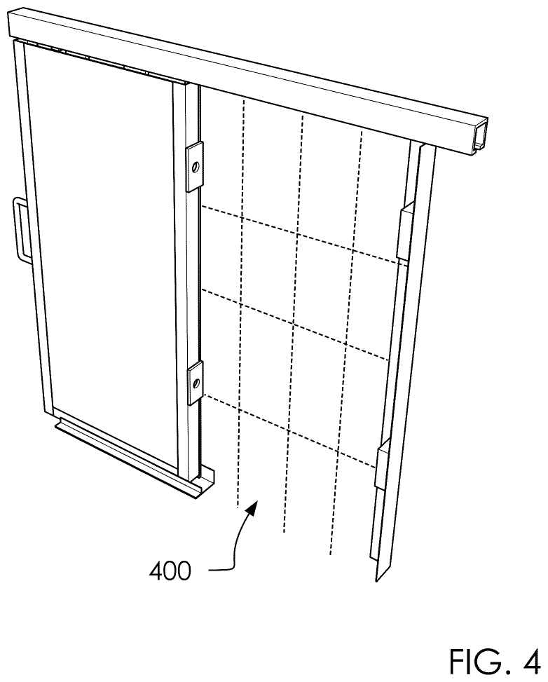

FIG. 4 illustrates a perspective overview of said reinforced door assembly 100.

To monitor the presence of any obstacle or person within said doorway 300, said reinforced door assembly 100 can further comprise a light curtain assembly 400 comprising one or more light sources 402 and one or more light sensors 404 mounted on opposite sides of said doorway 300.

Said one or more light sources 402 can emit light beams across said doorway 300, which can be detected by said one or more light sensors 404. If said light beams are interrupted by any object or person within said doorway 300, said one or more light sensors 404 can send a signal to said door control panel 200, which can prevent said door assembly 104 from moving towards said closed configuration 116 or stop it if it is already in motion. This can avoid any potential injury or damage caused by said door assembly 104 closing on said obstacle or person.

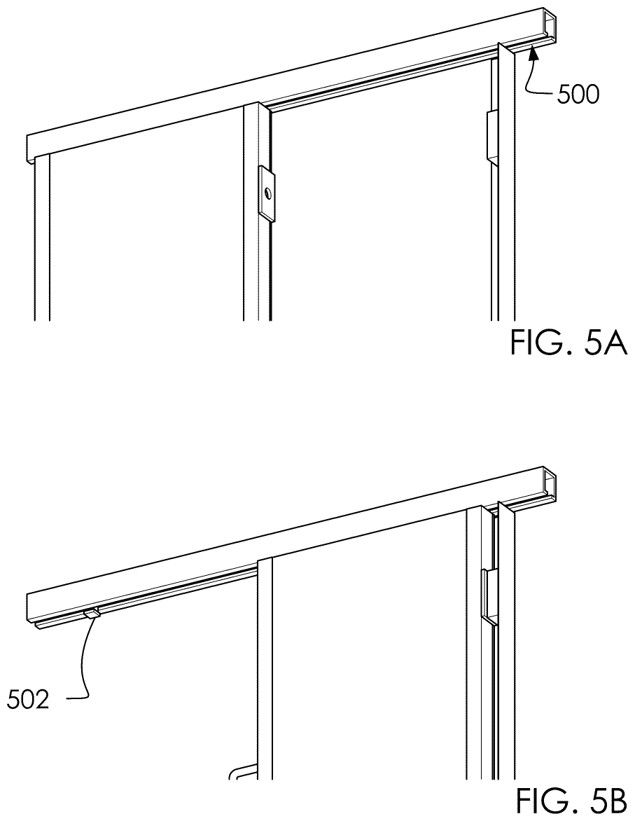

FIGS. 5A and 5B illustrate a lower perspective view of said reinforced door assembly 100 showing said upper track assembly 102a and said door assembly 104 in said open configuration 114 and said closed configuration 116, respectively.

In one embodiment, said reinforced door assembly 100 can further comprise a track blocking assembly 502.

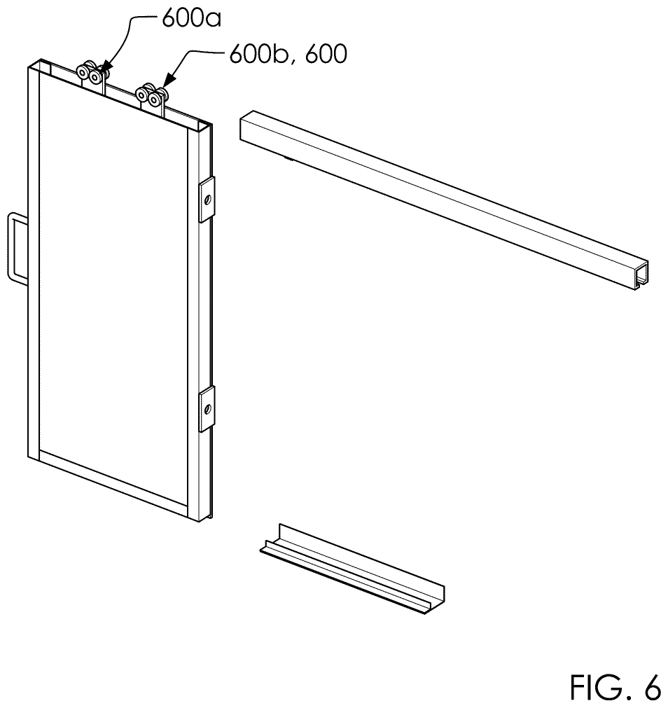

FIG. 6 illustrates an elevated overview of said reinforced door assembly 100 with said door assembly 104 detached from said one or more track assemblies 102.

In one embodiment, said reinforced door assembly 100 can comprise one or more track wheel assemblies 600 which can comprise a first track wheel assembly 600a and a second track wheel assembly 600b.

To accommodate the door's substantial weight and to ensure reliable operation, said one or more track wheel assemblies 600 can be integrated into the design. These rollers are selected for their safety and reliability over other alternatives, addressing potential settling issues and allowing for smooth operation along the tracks.

In one embodiment, said one or more track wheel assemblies 600 can hang down from and selectively slide within said upper track assembly 102a; wherein, a top portion 118 of said door assembly 104 can attach to said one or more track wheel assemblies 600. Thus, said door assembly 104 can slidably attach to said upper track assembly 102a using said one or more track wheel assemblies 600.

In one embodiment, said track blocking assembly 502 is configured to prevent said one or more track wheel assemblies 600 from rolling out of said upper track assembly 102a by blocking a track slot 500 in said upper track assembly 102a.

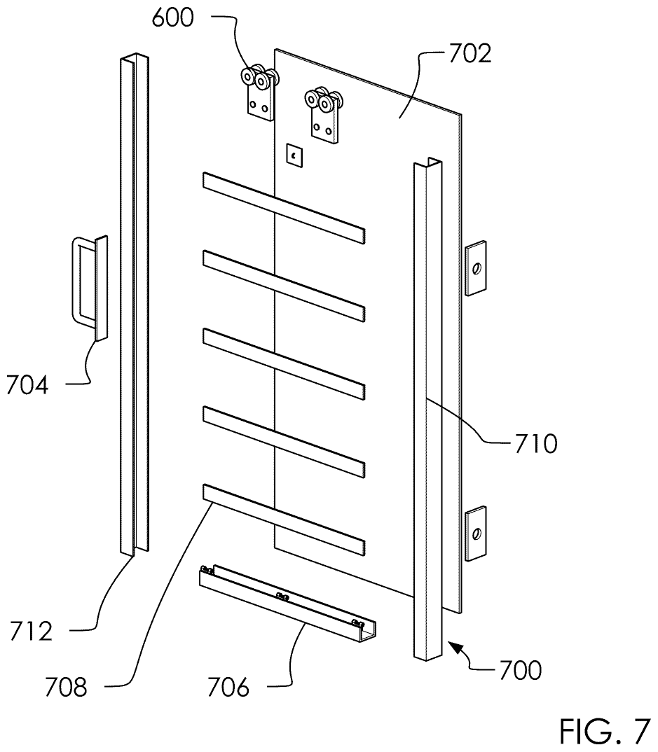

FIG. 7 illustrates an exploded elevated overview of said door assembly 104.

In one embodiment, said door assembly 104 is engineered for heightened security in educational environments, particularly to safeguard against active shooter scenarios.

In one embodiment, said reinforced door assembly 100 can comprise a structural frame 700, a doorway blocking portion 702, a handle 704, a lower portion 706, one or more horizontal reinforcement elements 708, a leading side portion 710, and a trailing side portion 712.

In one embodiment, said structural frame 700 can comprise said lower portion 706, said one or more horizontal reinforcement elements 708, said leading side portion 710 and said trailing side portion 712.

Said door assembly 104, especially said doorway blocking portion 702, can be

constructed from ⅜-inch thick AR500 steel, chosen for its ballistic resistance properties, providing robust protection against projectiles. This material is well-documented in prior art for its durability and use in shelters, including various configurations such as fold-out or scored designs. The robust nature of AR500 steel ensures that said door assembly 104 can withstand significant force, contributing to the overall security objective of said reinforced door assembly 100.

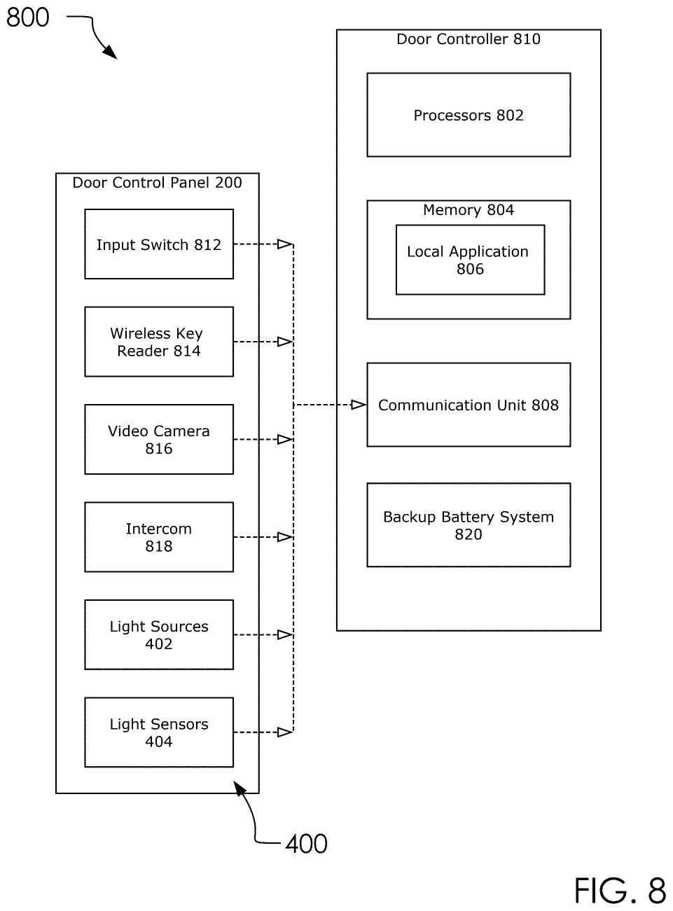

FIG. 8 illustrates a components diagram 800 of said reinforced door assembly 100.

In one embodiment, said reinforced door assembly 100 can comprise a door controller assembly 810 having one or more processors 802, a memory unit 804, a local application 806, and a communication unit 808.

In one embodiment, said door control panel 200 can comprise an input switch 812, and a wireless key reader 814, a video camera 816 creating a video stream in certain events, as discussed below, and an intercom 818.

In one embodiment, said reinforced door assembly 100 can further comprise a battery backup system 820 which can be configured to ensure functionality during power outages. In one embodiment, said battery backup system 820 can provide between five to seven hours of autonomous operation, thereby maintaining security protocols even in the event of an emergency that compromises the power supply.

Said one or more magnetic receiver assemblies 108 can be controlled electronically, and access can be granted through programmed RFID codes or a fire key, all managed by a dedicated computer controller. The controller can be not only responsible for access management but also for alerting users to potential threats, thereby streamlining the response to emergencies.

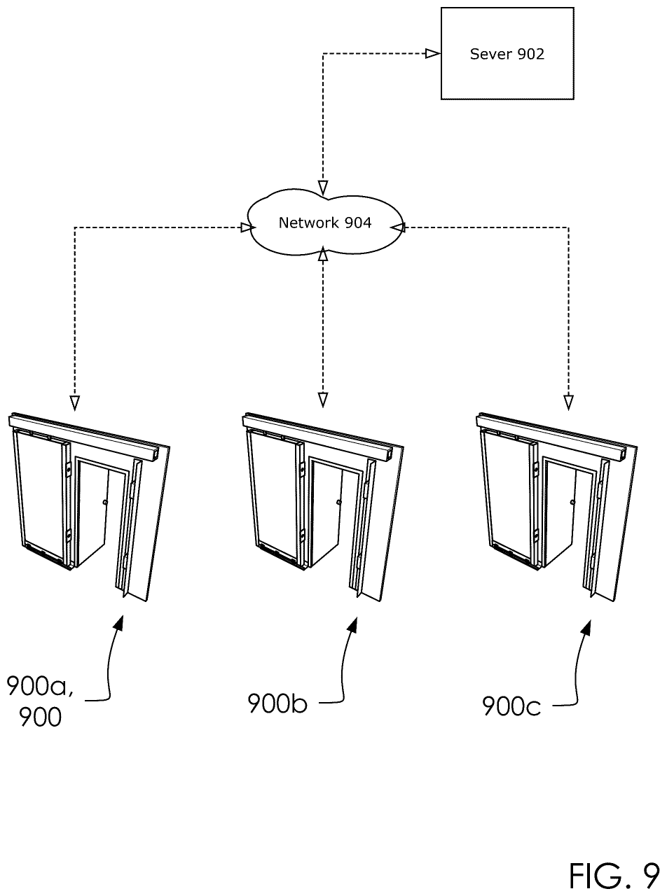

FIG. 9 illustrates an overview diagram of said reinforced door assembly 100 used in a network setting.

In one embodiment, a plurality of door assemblies 900 can communicate with a server 902 over a network 904 to facilitate a safety plan using said reinforced door assembly 100.

Said plurality of door assemblies 900 can comprise a first door assembly 900a and a second door assembly 900b.

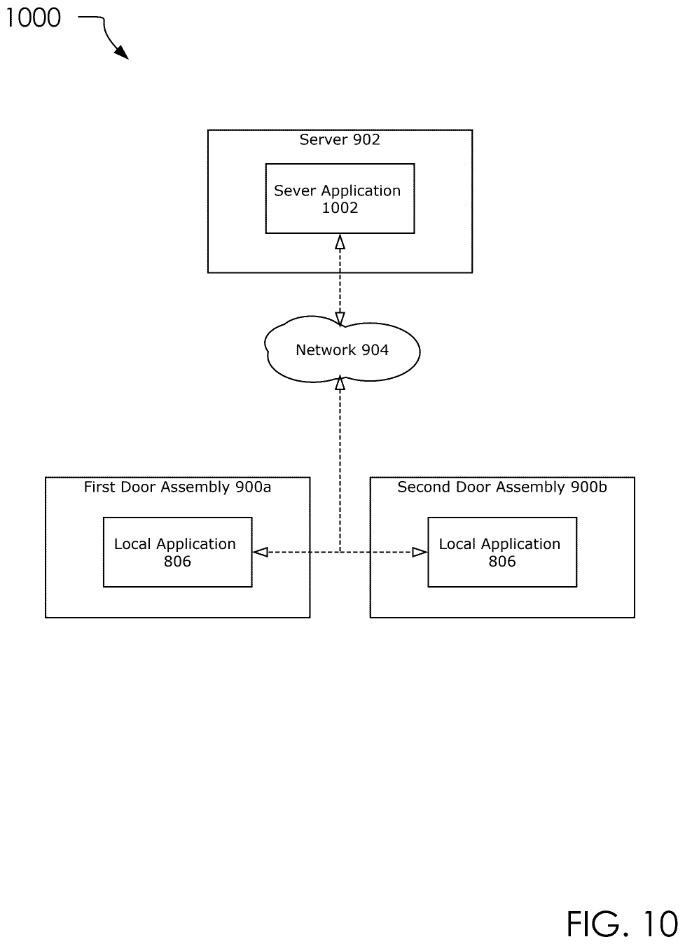

FIG. 10 illustrates a network diagram 1000 of said server 902 and said plurality of door assemblies 900.

As is known in the art, each computer among said plurality of door assemblies 900 and said server 902 can comprise said one or more processors 802, said memory unit 804 and said communication unit 808. Wherein, said server 902 can comprise a server application 1002 in said memory unit 804 of said server 902; and each among said plurality of door assemblies 900 and said server 902 can communicate using said communication unit 808 for that computer, respectively.

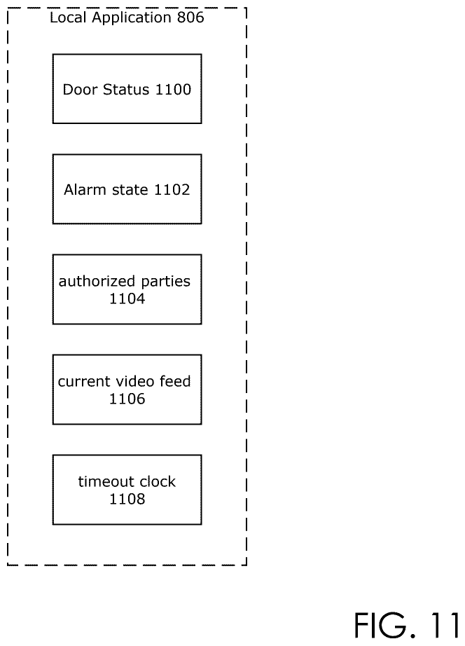

FIG. 11 illustrates a block diagram of said local application 806 integrated within the security enhancement system.

Said server application 1002 in conjunction with said local application 806 of said plurality of door assemblies 900 are configured to monitor a status of said plurality of door assemblies 900.

In one embodiment, said local application 806 can comprise a door status field 1100, an alarm state field 1102, an authorized-parties object 1104 and a current video feed 1106, and a timeout clock 1108.

Wherein, said network diagram 1000 can be responsible for tracking and displaying the status of said door assembly 104. Further, it can measure whether said door assembly 104 is in said open configuration 114 and said closed configuration 116, or therebetween. In one embodiment, this real-time status information ensures that users are informed about the positioning of said reinforced door assembly 100.

Further, said alarm state field 1102 can comprise the security system's readiness and can indicate different states, such as “Armed,” “Disarmed,” or “Alert.” Changes in this field trigger responses based on the system's security protocols.

In one embodiment, said authorized-parties object 1104 can comprise a field to manage and specify authorized parties who have access to control said reinforced door assembly 100 and its configurations. Depending on the security requirements, said authorized-parties object 1104 can be set to grant access in said open configuration 114 or restrict access in said closed configuration 116, aligning with the discussed security protocols.

Finally, said current video feed 1106 can represent a video stream within said local application 806, which can display real-time video footage from surveillance cameras situated in proximity to said reinforced door assembly 100. This live video feed enhances situational awareness, allowing users to monitor activities around said reinforced door assembly 100.

The block diagram in FIG. 11 highlights the interconnectedness of these components within the local application, emphasizing their roles in ensuring the security and functionality of said reinforced door assembly 100. Said local application 806 can be employed in managing and responding to security events, seamlessly integrating with the overall security enhancement system.

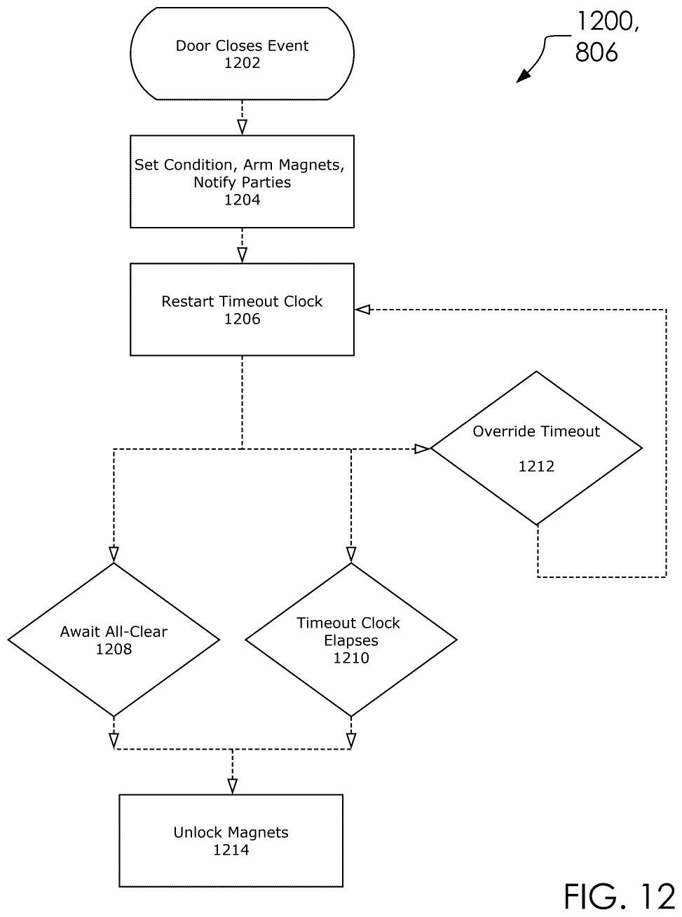

FIG. 12 illustrates a local app flowchart 1200.

Said local app flowchart 1200 can comprise one protocol concerning the operational sequence of said reinforced door assembly 100 during a lockdown event.

In one embodiment, said local app flowchart 1200 comprises a door closing event 1202, a first step 1204, a second step 1206, an await condition 1208, an elapsed time condition 1210, an override condition 1212, and an unlock door step 1214, as illustrated.

In one embodiment, said local application 806 can be configured to implement said local app flowchart 1200 in software and rendered on said one or more processors 802.

In one embodiment, said local application 806 can be configured to monitor said door status field 1100 related to an open or closed condition of said door assembly 104. Wherein, when said door assembly 104 is moved into said closed configuration 116, said door closing event 1202 is triggered and said alarm state field 1102 is raised to a preliminary alarm state. Likewise, said one or more magnetic receiver assemblies 108 can activate and magnetically hold said one or more ferromagnetic plates 112.

Subsequently, said door controller assembly 810 sets a digital condition for said door assembly 104, indicating its closed and secure status.

Following this, said one or more magnetic receiver assemblies 108 are armed, ensuring said door assembly 104 remains firmly held in said closed configuration 116.

In one embodiment, said local application 806 can be configured to start said timeout clock 1108 using said first step 1204.

Concurrently, a notification is dispatched to all relevant parties, informing them of the lockdown status of said reinforced door assembly 100. This ensures that all necessary individuals are aware of the security condition. A portion of such parties may be stored in said authorized-parties object 1104 of said local application 806.

In one embodiment, said timeout clock 1108 can comprise a safety feature designed to prevent permanent lockdown. It can be configured via software to set a predetermined period after which said door assembly 104 will automatically unlock if not manually overridden.

Referring to said second step 1206 and said override condition 1212, it is noted that an override timeout feature is available. This feature allows for an extended lockdown period beyond the standard timeout clock. This extended period can be set either through software configurations or via a physical button located within the safety room.

Concerning said await condition 1208, said local application 806 can be configured to receive feedback from said server application 1002. For example, an “Await All Clear Signal” can be received by said local application 806. In one embodiment, said door assembly 104 can remain locked state until a centralized all-clear signal is received. This signal allows for the simultaneous unlocking of all doors in a facility such as a school building, indicating the end of a lockdown event.

Concerning said elapsed time condition 1210, said local application 806 is configured to unlock said door assembly 104 according to a lapse of the predetermined timeout period, initiating the process to unlock said door assembly 104.

Accordingly, said unlock door step 1214 comprises unlocking said one or more magnetic receiver assemblies 108, which allows said door assembly 104 to transition back to said open configuration 114, thus concluding the lockdown sequence.

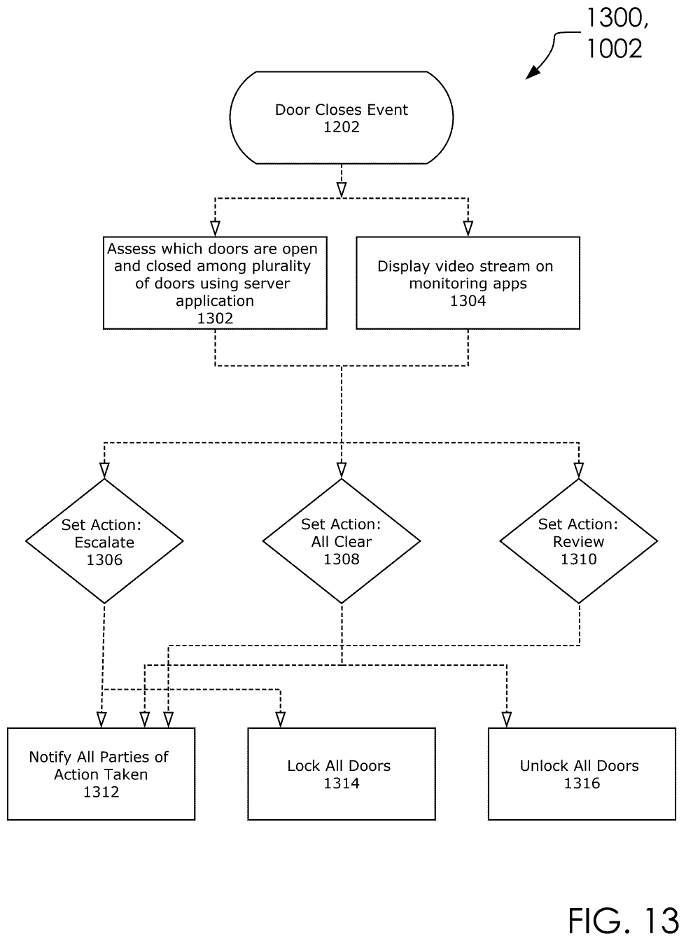

FIG. 13 illustrates a server action flowchart 1300 for said server application 1002.

Said server action flowchart 1300 outlines one protocol followed by said server application 1002 in response to the closing of one door among many in a facility.

Said server action flowchart 1300 can comprise said door closing event 1202, a system assessment step 1302, a display video stream step 1304, an escalate action 1306, an all-clear action 1308, a review action 1310, a notification step 1312, a lockdown step 1314 and an unlock step 1316.

Said server action flowchart 1300 initiates with said door closing event 1202 indicating that one of the plurality of doors within the facility has transitioned to a closed state.

Said system assessment step 1302 involves said server application 1002 assessing the status of all doors in the facility, categorizing them as either open or closed.

Concurrently, said display video stream step 1304, a parallel block, indicates that a video stream can be activated, providing an administrator with a visual overview of the situation at the doors and surrounding areas of the facility.

Following these initial steps, the flowchart splits into three parallel action blocks: said escalate action 1306, said all-clear action 1308 and said review action 1310. Wherein, said escalate action 1306 can comprise said server application 1002 receiving a signal from an administrator or responsible party, using said server application 1002 or other trusted means, to escalate the situation if there is cause for concern, triggering further notifications and actions. Said all-clear action 1308 can comprise receiving a signal from a trusted user that there is no emergency, effectively resolving any concerns. Finally, said review action 1310 can comprise an indication that the situation is unclear, prompting a need for further review and analysis.

Below these parallel action blocks, three corresponding event blocks are depicted: said notification step 1312, said lockdown step 1314 and said unlock step 1316. Wherein, said notification step 1312 can comprise the action of notifying all parties of action taken regardless of the action chosen (Escalate, All Clear, or Review), this event ensures that all relevant parties are informed about the action being taken. Said lockdown step 1314 can comprise an event triggered if the “Set Action to Escalate” is selected, implementing a facility-wide lockdown. Wherein, said server application 1002 can automatically lock said plurality of door assemblies 900 within a facility. Finally, said unlock step 1316 can comprise an event for unlocking all said plurality of door assemblies 900. This event occurs only if the “Set Action to All Clear” is chosen, signaling the end of a concern and restoring normal access throughout the facility.

In one embodiment, said light curtain assembly 400 can be engaged to verify a safety condition within said doorway 300 and said reinforced door assembly 100 can be configured with motors to automatically close said door assembly 104.

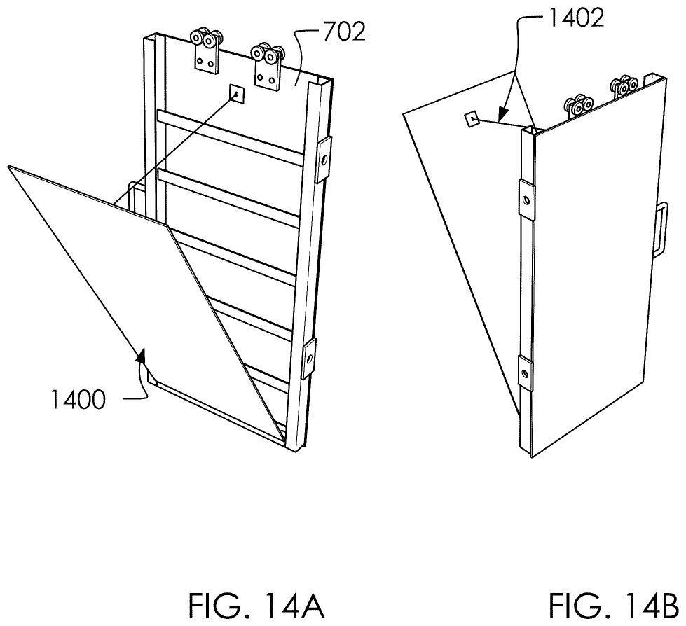

FIGS. 14A and 14B illustrate a perspective overview from a front and rear vantage of said door assembly 104 with a whiteboard insert 1400 being removed.

In one embodiment, said reinforced door assembly 100 can further comprise said whiteboard insert 1400.

Furthermore, a child-friendly aspect can be introduced by attaching said whiteboard insert 1400 to said door assembly 104. This not only conceals the industrial appearance of the steel door but also allows for an interactive and decorative surface, contributing to a more welcoming environment for students while maintaining its defensive purpose.

Said door assembly 104 can be a testament to the project's goal to meld advanced locking mechanisms and monitoring capabilities with practical design considerations, creating a reinforced door that enhances safety in school settings while being mindful of the environment in which it operates.

In one embodiment, said reinforced door assembly 100 can further comprise a tether 1402 to ensure said whiteboard insert 1400 does not fall onto users of said reinforced door assembly 100. As illustrated, said tether 1402 can selectively secure said whiteboard insert 1400 to a portion of said structural frame 700 or said doorway blocking portion 702.

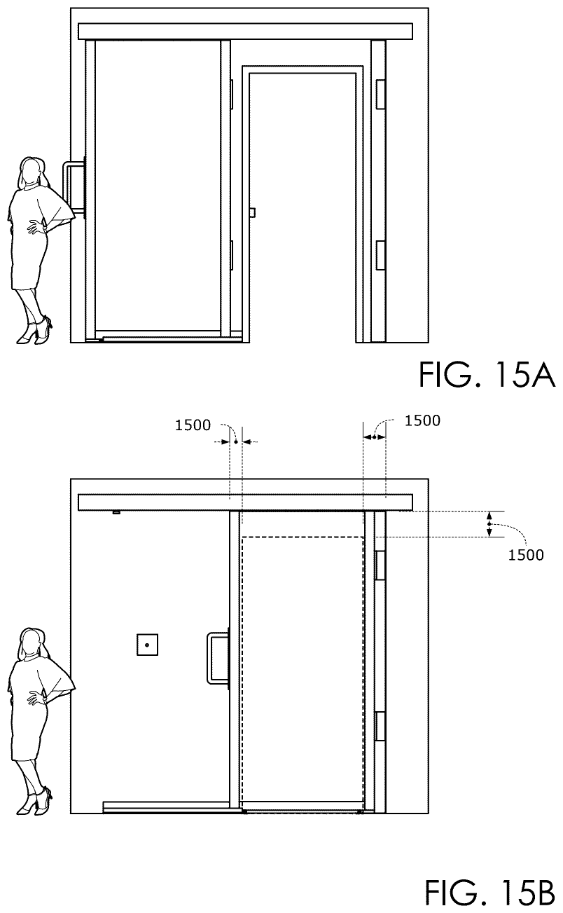

FIGS. 15A and 15B illustrate an elevated front view of said reinforced door assembly 100 installed around said doorway 300 and in said open configuration 114 and said closed configuration 116, respectively.

When in said closed configuration 116, said door assembly 104 can be designed to overlap the surrounding walls by a wall overlap 1500. In one embodiment, said wall overlap 1500 can comprise at least 4 inches on three sides, providing additional protective measures by trapping any projectiles between the door and the wall.

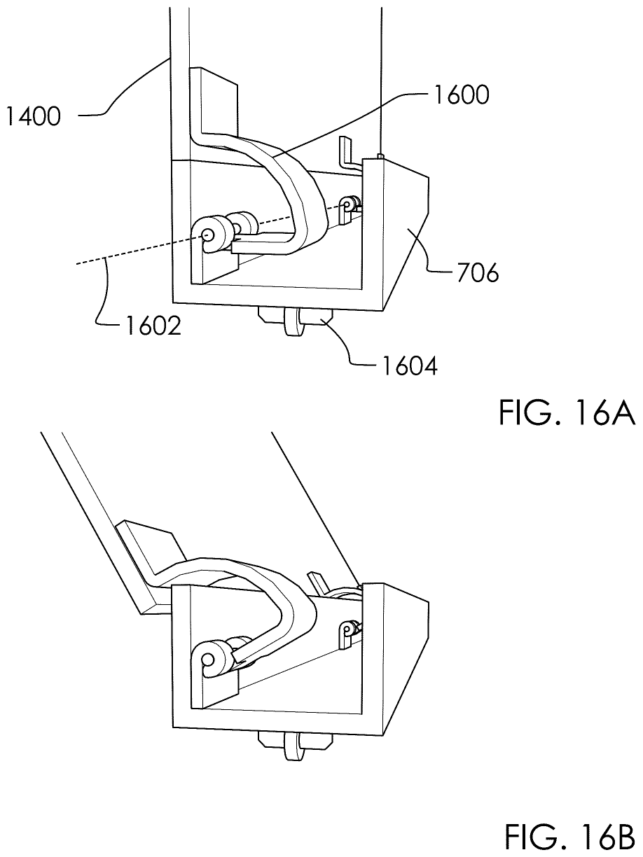

FIGS. 16A and 16B illustrate two perspective views of said lower portion 706 and said whiteboard insert 1400.

In one embodiment, said lower portion 706 can comprise one or more hinge assemblies 1600 configured to rotateably connected said whiteboard insert 1400 with said lower portion 706 about a whiteboard axis 1602.

As shown, said one or more hinge assemblies 1600 are configured to be mounted within a portion of said lower portion 706 to maintain a flat face on said whiteboard insert 1400 with respect to said lower portion 706.

In one embodiment, said lower portion 706 can further comprise one or more lower support wheel assemblies 1604 configured to support the weight of said reinforced door assembly 100 on the ground or within said lower track assembly 102b.

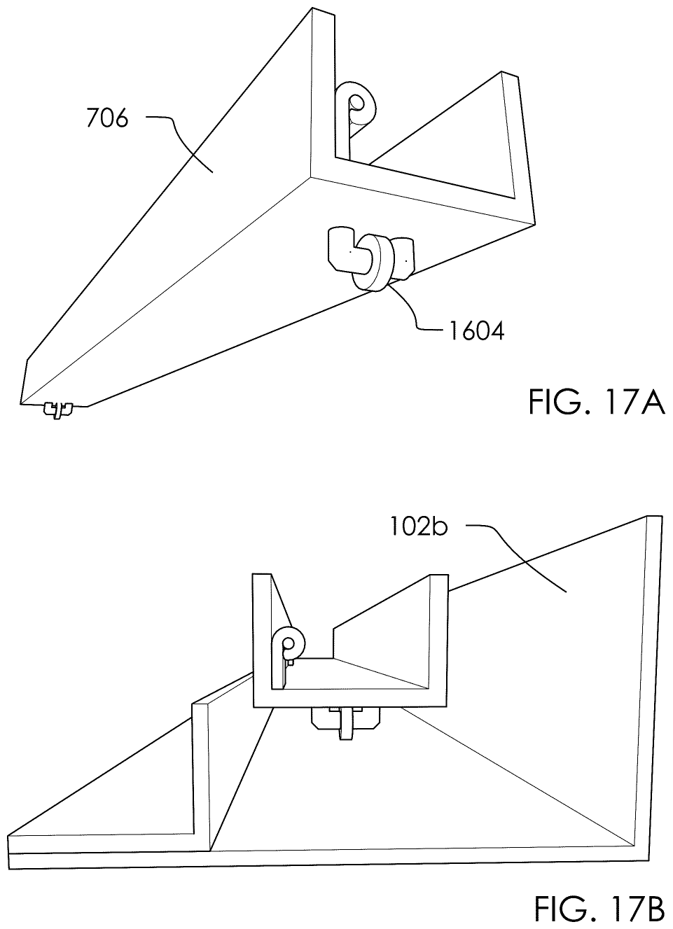

FIGS. 17A and 17B illustrate two perspective views of said lower portion 706 with said one or more lower support wheel assemblies 1604 and said lower track assembly 102b.

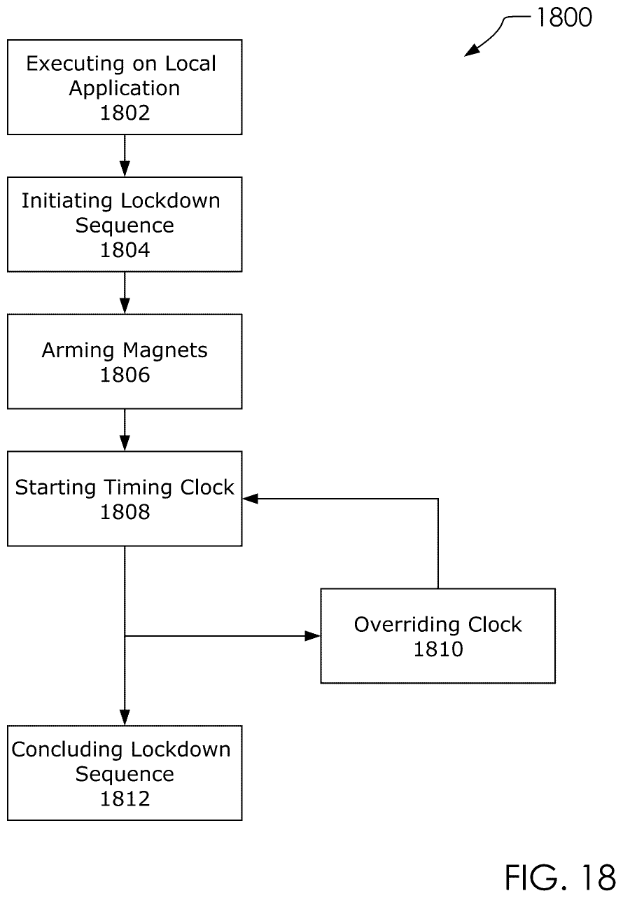

FIG. 18 illustrates a flow chart of a method of use 1800 of said reinforced door assembly 100.

In one embodiment, said method of use 1800 can comprise an executing step 1802, an initiating lockdown step 1804, an arming magnets step 1806, a starting timing clock step 1808, an overriding step 1810 and a concluding step 1812, as discussed below.

In one embodiment, said executing step 1802 can comprise executing, on said one or more processors 802, said local application 806 configured to control said reinforced door assembly 100; said initiating lockdown step 1804 can comprise initiating a lockdown sequence upon said one or more processors 802 detecting said door closing event 1202; said arming magnets step 1806 can comprise arming, via said local application 806, said one or more magnetic receiver assemblies 108 to secure said door assembly 104 in said closed configuration 116; said starting timing clock step 1808 can comprise starting, by said local application 806, said timeout clock 1108 to count down to an automatic release of said door assembly 104 from said closed configuration 116; said overriding step 1810 can comprise overriding, upon said local application 806 receiving an override command, said timeout clock 1108 for an extended lockdown period;

and said concluding step 1812 can comprise concluding the lockdown sequence by disengaging said one or more magnetic receiver assemblies 108 to transition said door assembly 104 to said open configuration 114 in response to an all-clear signal or upon elapse of said timeout clock 1108.

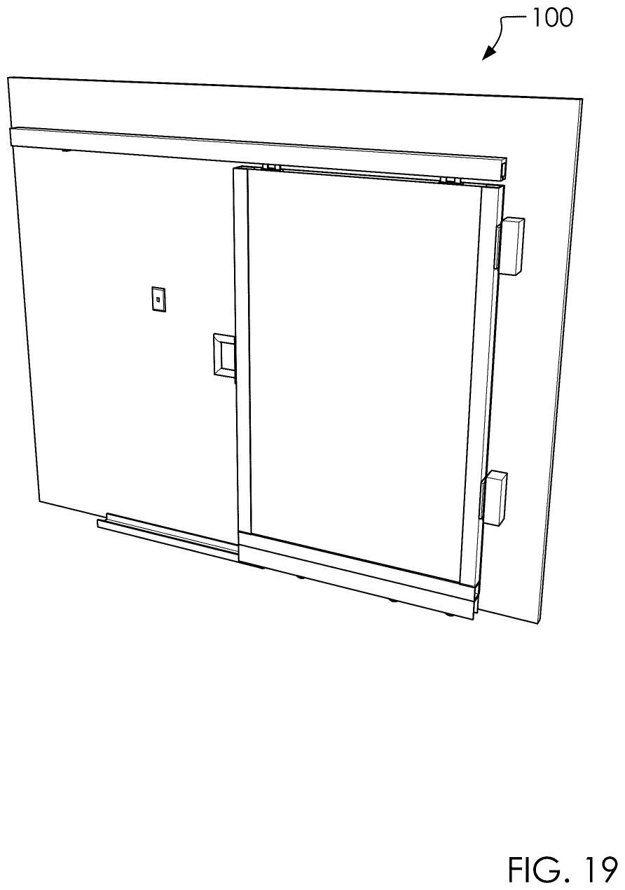

FIG. 19 illustrates a perspective overview of said reinforced door assembly 100.

Illustrated here, said reinforced door assembly 100 comprises an improved hinging configuration as discussed below.

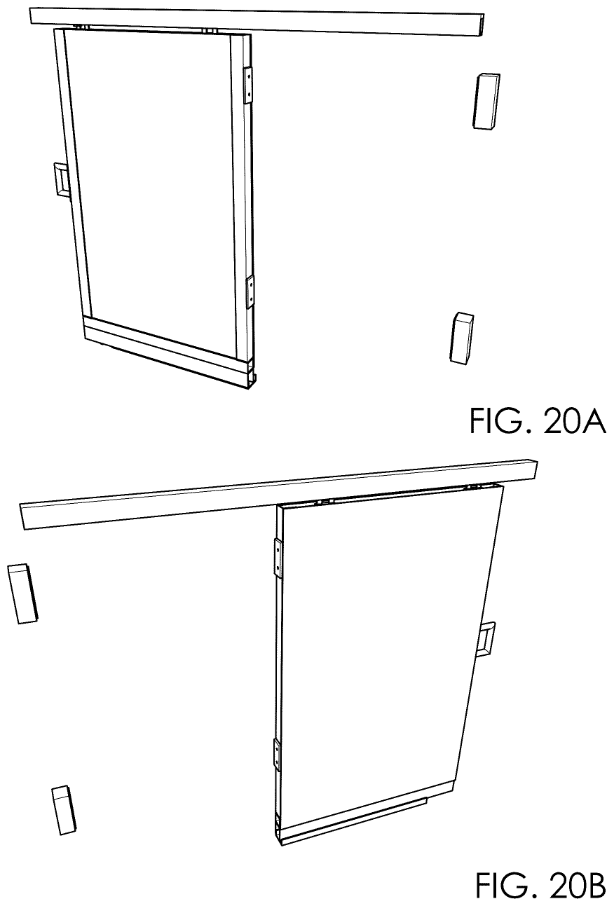

FIGS. 20A and 20B illustrate a perspective frontside and rear side view of said reinforced door assembly 100.

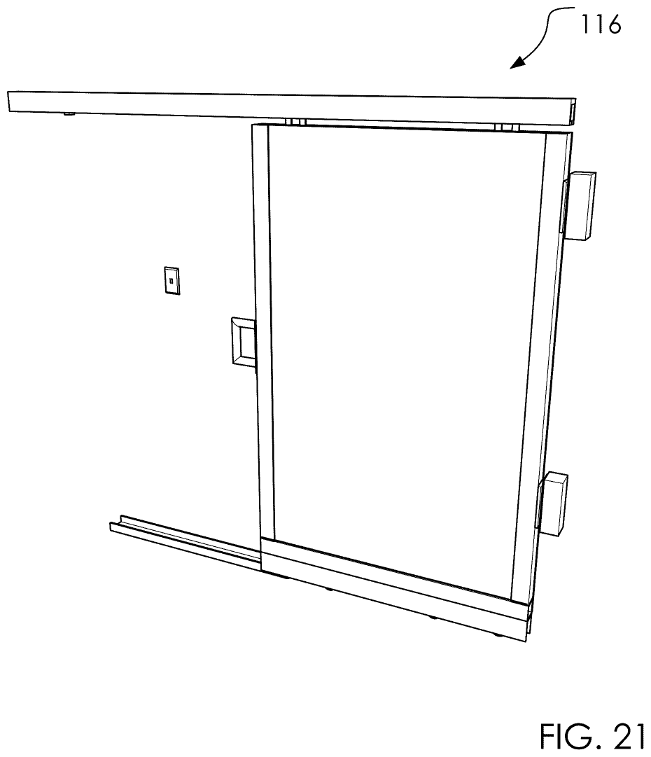

FIG. 21 illustrates a perspective overview of said reinforced door assembly 100 in said closed configuration 116.

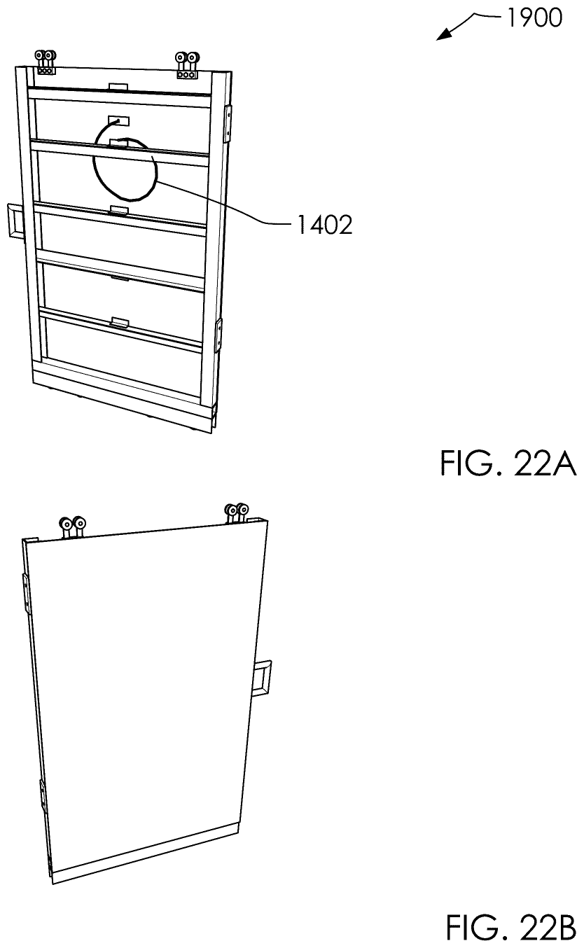

FIGS. 22A and 22B illustrate a perspective frontside and rear side view of said reinforced door assembly 100 without said whiteboard insert 1400.

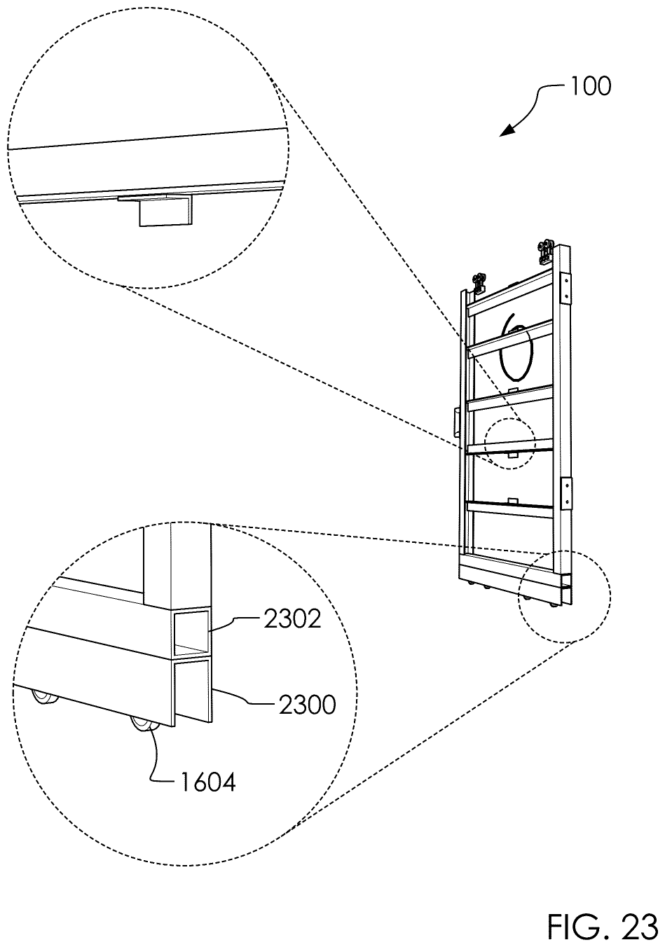

FIG. 23 illustrates a perspective overview of said reinforced door assembly 100 without said whiteboard insert 1400.

In one embodiment, said reinforced door assembly 100 can comprise a lower c-channel 2300, a lower square tubing 2302 and said one or more lower support wheel assemblies 1604.

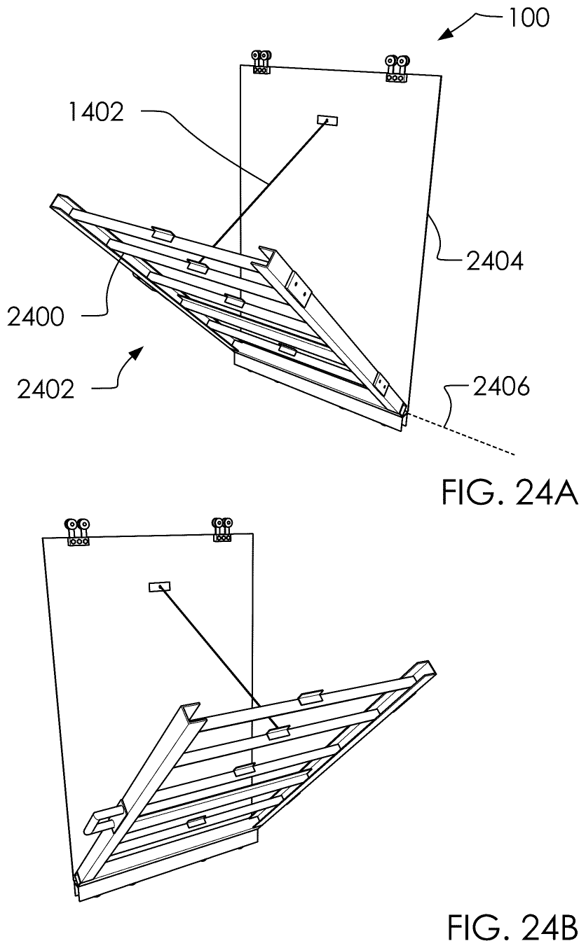

FIGS. 24A and 24B illustrate a perspective front view of said reinforced door assembly 100 with a hinged portion 2400 in a lowered configuration 2402.

In one embodiment, said reinforced door assembly 100 can comprise an unhinged portion 2404 and said hinged portion 2400 configured to selectively rotate relative to one another about a hinge axis 2406.

In one embodiment, said hinged portion 2400 can be secured to said unhinged portion 2404 using said tether 1402. And said hinged portion 2400 can be further secured by using fasteners such as bolts to hold said hinged portion 2400 against said unhinged portion 2404.

In one embodiment, said hinged portion 2400 can comprise said lower c-channel 2300, said one or more track wheel assemblies 600, said doorway blocking portion 702, and said one or more lower support wheel assemblies 1604.

In one embodiment, said lowered configuration 2402 can comprise said one or more horizontal reinforcement elements 708, said leading side portion 710, said trailing side portion 712, and said handle 704.

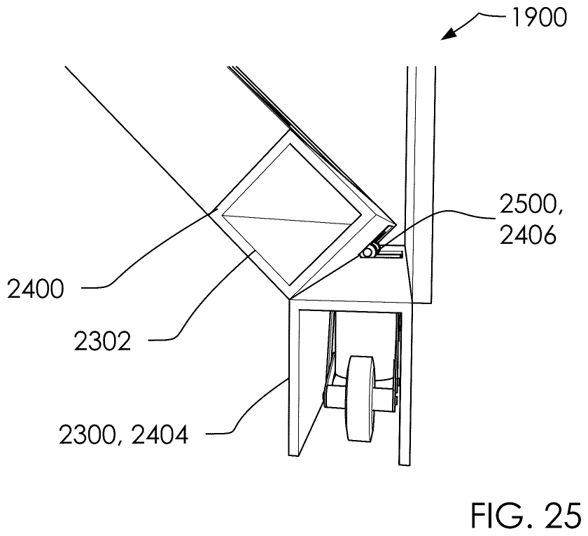

FIG. 25 illustrates a lower hinge assembly 2500 of said reinforced door assembly 100.

In one embodiment, said lower hinge assembly 2500 can selectively rotate about said hinge axis 2406 to allow said hinged portion 2400 to rotate relative to said unhinged portion 2404. In one embodiment, said lower hinge assembly 2500 can be attached to a portion of said lower c-channel 2300 and said lower square tubing 2302, as illustrated.

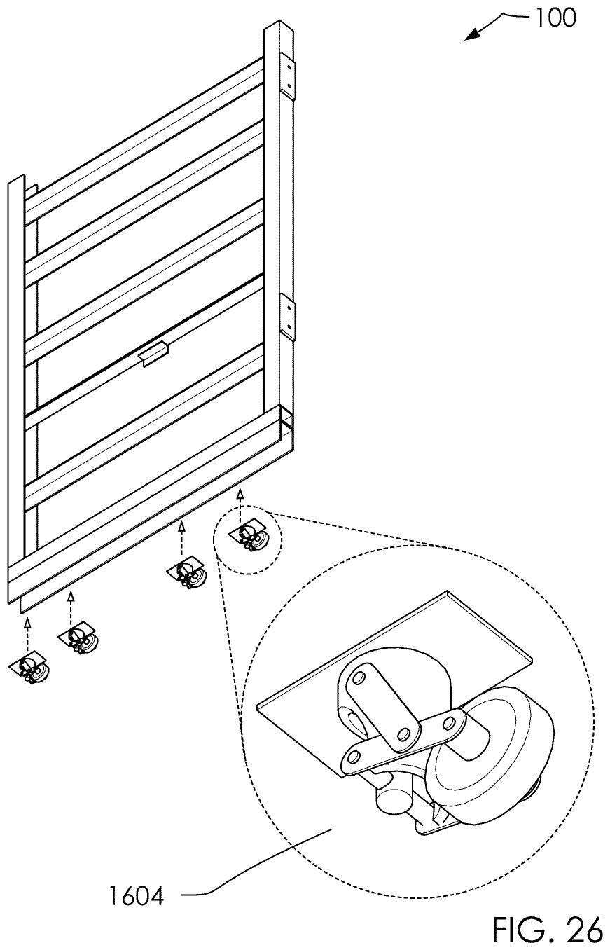

FIG. 26 illustrates a perspective overview of said reinforced door assembly 100 with a detailed view of said one or more lower support wheel assemblies 1604.

### Parts List

said reinforced door assembly 100,
said one or more track assemblies 102,
said door assembly 104,
said one or more magnetic receiver assemblies 108,
said stopper assembly 110,
said one or more ferromagnetic plates 112,
said first ferromagnetic plate 112a,
said second ferromagnetic plate 112b,
said first magnetic receiver assemblies 108a,
said second magnetic receiver assemblies 108b,
said upper track assembly 102a,
said lower track assembly 102b,
said open configuration 114,
said closed configuration 116,
said door control panel 200,
said doorway 300,
said door 302,
said open-door configuration 304,
said light curtain assembly 400,
said one or more light sources 402,
said one or more light sensors 404,
said track blocking assembly 502,
said one or more track wheel assemblies 600,
said first track wheel assembly 600a,
said second track wheel assembly 600b,
said top portion 118,
said track slot 500,
said structural frame 700,
said doorway blocking portion 702,
said handle 704,
said lower portion 706,
said one or more horizontal reinforcement elements 708,
said leading side portion 710,
said trailing side portion 712,
said components diagram 800,
said door controller assembly 810,
said one or more processors 802,
said memory unit 804,
said local application 806,
said communication unit 808,
said input switch 812,
said wireless key reader 814,
said video camera 816,
said intercom 818,
said battery backup system 820,
said plurality of door assemblies 900,
said server 902,
said network 904,
said first door assembly 900a,
said second door assembly 900b,
said network diagram 1000,
said server application 1002,
said door status field 1100,
said alarm state field 1102,
said authorized-parties object 1104,
said current video feed 1106,
said timeout clock 1108,
said local app flowchart 1200,
said door closing event 1202,
said first step 1204,
said second step 1206,
said await condition 1208,
said elapsed time condition 1210,
said override condition 1212,
said unlock door step 1214,
said server action flowchart 1300,
said system assessment step 1302,
said display video stream step 1304,
said escalate action 1306,
said all-clear action 1308,
said review action 1310,
said notification step 1312,
said lockdown step 1314,
said unlock step 1316,
said whiteboard insert 1400,
said tether 1402,
said wall overlap 1500,
said one or more hinge assemblies 1600,
said whiteboard axis 1602,
said one or more lower support wheel assemblies 1604,
said method of use 1800,
said executing step 1802,
said initiating lockdown step 1804,
said arming magnets step 1806,
said starting timing clock step 1808,
said overriding step 1810,
said concluding step 1812,
said lower c-channel 2300,
said lower square tubing 2302,
said hinged portion 2400,
said lowered configuration 2402,
said unhinged portion 2404,
said hinge axis 2406, and
said lower hinge assembly 2500.

### Preferred Embodiment

With reference to the original claims, this disclosure selects the following as its preferred embodiment.

Said reinforced door assembly 100 for selectively barricading said doorway 300 of a protected room. Said reinforced door assembly 100 comprises said one or more track assemblies 102, said door assembly 104, said one or more track wheel assemblies 600, said one or more magnetic receiver assemblies 108 on said stopper assembly 110, and said one or more ferromagnetic plates 112. Said reinforced door assembly 100 can be installed on a wall within a protected room, such as a school classroom. Said one or more track assemblies 102 can be aligned with and partially surrounds said doorway 300. Said door assembly 104 can be configured to selectively slide between said open configuration 114 and said closed configuration 116 along said one or more track assemblies 102. Said open configuration 114 comprises said door assembly 104 not blocking said doorway 300. Said closed configuration 116 comprises barricading said doorway 300 with said door assembly 104. Said one or more track assemblies 102 comprises at least said upper track assembly 102a. Said door assembly 104 slidably attach to said upper track assembly 102a using said one or more track wheel assemblies 600. Said one or more track wheel assemblies 600 hang down from and selectively slide within said upper track assembly 102a. Said top portion 118 of said door assembly 104 attach to said one or more track wheel assemblies 600. With said reinforced door assembly 100 in said closed configuration 116, said one or more magnetic receiver assemblies 108 and said one or more ferromagnetic plates 112 attached to one another. Said one or more magnetic receiver assemblies 108 comprises a 1200-pound magnet, providing a secure hold when the door can be in the closed position. Said reinforced door assembly 100 comprises said structural frame 700. Said door assembly 104 can be constructed from ⅜-inch thick AR500 steel, chosen for its ballistic resistance properties, providing robust protection against projectiles.

Said reinforced door assembly 100 for selectively barricading said doorway 300 of a protected room. Said reinforced door assembly 100 comprises said one or more track assemblies 102, said door assembly 104, said one or more track wheel assemblies 600, said one or more magnetic receiver assemblies 108 on said stopper assembly 110, and said one or more ferromagnetic plates 112. Said reinforced door assembly 100 can be installed on a wall within a protected room, such as a school classroom. Said one or more track assemblies 102 can be aligned with and partially surrounds said doorway 300. Said door assembly 104 can be configured to selectively slide between said open configuration 114 and said closed configuration 116 along said one or more track assemblies 102. Said open configuration 114 comprises said door assembly 104 not blocking said doorway 300. Said closed configuration 116 comprises barricading said doorway 300 with said door assembly 104. Said one or more track assemblies 102 comprises at least said upper track assembly 102a. Said door assembly 104 slidably attach to said upper track assembly 102a using said one or more track wheel assemblies 600. Said one or more track wheel assemblies 600 hang down from and selectively slide within said upper track assembly 102a. Said top portion 118 of said door assembly 104 attach to said one or more track wheel assemblies 600. With said reinforced door assembly 100 in said closed configuration 116, said one or more magnetic receiver assemblies 108 and said one or more ferromagnetic plates 112 attached to one another. Said one or more magnetic receiver assemblies 108 comprises a 1200-pound magnet, providing a secure hold when the door can be in the closed position. Said reinforced door assembly 100 comprises said structural frame 700. Said door assembly 104 can be constructed from ⅜-inch thick AR500 steel, chosen for its ballistic resistance properties, providing robust protection against projectiles.

Said reinforced door assembly 100 for selectively barricading said doorway 300 of a protected room. Said reinforced door assembly 100 comprises said one or more track assemblies 102, said door assembly 104, said one or more track wheel assemblies 600, said one or more magnetic receiver assemblies 108 on said stopper assembly 110, and said one or more ferromagnetic plates 112. Said reinforced door assembly 100 can be installed on a wall within a protected room, such as a school classroom. Said one or more track assemblies 102 can be aligned with and partially surrounds said doorway 300. Said door assembly 104 can be configured to selectively slide between said open configuration 114 and said closed configuration 116 along said one or more track assemblies 102. Said open configuration 114 comprises said door assembly 104 not blocking said doorway 300. Said closed configuration 116 comprises barricading said doorway 300 with said door assembly 104.

Said reinforced door assembly 100 can further comprise said whiteboard insert 1400.

When in said closed configuration 116, said door assembly 104 can be designed to overlap the surrounding walls by said wall overlap 1500.

Said wall overlap 1500 comprises at least 4 inches on three sides, providing additional protective measures by trapping any projectiles between the door and the wall.

Said one or more track assemblies 102 comprises at least said upper track assembly 102a. Said door assembly 104 slidably attach to said upper track assembly 102a using said one or more track wheel assemblies 600. Said one or more track wheel assemblies 600 hang down from and selectively slide within said upper track assembly 102a. Said top portion 118 of said door assembly 104 attach to said one or more track wheel assemblies 600.

With said reinforced door assembly 100 in said closed configuration 116, said one or more magnetic receiver assemblies 108 and said one or more ferromagnetic plates 112 attached to one another. Said one or more magnetic receiver assemblies 108 comprises a 1200-pound magnet, providing a secure hold when the door can be in the closed position.

Said reinforced door assembly 100 further comprises said structural frame 700. Said door assembly 104 can be constructed from ⅜-inch thick AR500 steel, chosen for its ballistic resistance properties, providing robust protection against projectiles.

Said reinforced door assembly 100 further comprises said door control panel 200. Said door control panel 200 can be installed behind said door assembly 104 with said door assembly 104 in said open configuration 114. Said reinforced door assembly 100 comprises said door controller assembly 810 having said one or more processors 802, said memory unit 804, said local application 806, and said communication unit 808. Wherein, said reinforced door assembly 100 can be configured for initiating on said local application 806, running on said one or more processors 802 the following steps. Initiating a lockdown sequence upon detecting said door closing event 1202, arming said one or more magnetic receiver assemblies 108 to secure said door assembly 104 in said closed configuration 116, starting said timeout clock 1108 to count down to an automatic unlocking of said door assembly 104, overriding upon receiving an override command, said timeout clock 1108 for an extended lockdown period, and concluding the lockdown sequence by unlocking said one or more magnetic receiver assemblies 108 in response to an all-clear signal or the lapsation of said timeout clock 1108. Said door control panel 200 comprises said input switch 812, and said wireless key reader 814, said video camera 816 creating a video stream in certain events, as discussed below, and said intercom 818.

Said reinforced door assembly 100 further comprising said battery backup system 820 which can be configured to ensure functionality during power outages. Said battery backup system 820 configured to provide between five to seven hours of autonomous operation, thereby maintaining security protocols even in the event of an emergency that compromises the power supply.

Said one or more magnetic receiver assemblies 108 can be controlled electronically, and access can be granted through a key, such as a fire key or electronic identity verification.

Said reinforced door assembly 100 comprises said first door assembly 900a among said plurality of door assemblies 900. Said plurality of door assemblies 900 can be connected to said network 904 and managed by said server application 1002 on said server 902. Said server application 1002 can be configured to facilitate a safety plan using said reinforced door assembly 100. Each among said plurality of door assemblies 900 and said server 902 comprises said one or more processors 802, said memory unit 804 and said communication unit 808. Said server 902 comprises said server application 1002 in said memory unit 804 of said server 902. Each among said plurality of door assemblies 900 and said server 902 communicate using said communication unit 808 for that computer, respectively. Said server application 1002 executed on said one or more processors 802 of said server 902, wherein said server application 1002 can be configured for: monitoring said plurality of door assemblies 900 connected to said network 904. Determining the status of each among said plurality of door assemblies 900 as open or closed. Activating said video camera 816 corresponding to the closed door assembly for real-time monitoring. Receiving one of an escalation command, an all-clear command, and a review command. Executing based on the received command, one of a lockdown procedure, a status notification procedure, and an unlock procedure for said plurality of door assemblies 900.

Said server application 1002 in conjunction with said local application 806 of said plurality of door assemblies 900 can be configured to monitor a status of said plurality of door assemblies 900.

Said reinforced door assembly 100 comprises said lower c-channel 2300, said lower square tubing 2302 and said one or more lower support wheel assemblies 1604. Said reinforced door assembly 100 comprises said unhinged portion 2404 and said hinged portion 2400 configured to selectively rotate relative to one another about said hinge axis 2406. Said hinged portion 2400 can be secured to said unhinged portion 2404 using said tether 1402.

Said hinged portion 2400 comprises said lower c-channel 2300, said one or more track wheel assemblies 600, said doorway blocking portion 702, and said one or more lower support wheel assemblies 1604. Said lowered configuration 2402 comprises said one or more horizontal reinforcement elements 708, said leading side portion 710, said trailing side portion 712, and said handle 704.

Said hinged portion 2400 can be further secured by using fasteners such as bolts to hold said hinged portion 2400 against said unhinged portion 2404.

Said lower hinge assembly 2500 can be configured to selectively rotate about said hinge axis 2406 to allow said hinged portion 2400 to rotate relative to said unhinged portion 2404. Said lower hinge assembly 2500 can be attached to a portion of said lower c-channel 2300 and said lower square tubing 2302, as illustrated.

Said method of use 1800 for managing security in a protected room using said reinforced door assembly 100, the method can comprise executing, on said one or more processors 802, said local application 806 configured to control said reinforced door assembly 100. Initiating a lockdown sequence upon said one or more processors 802 detecting said door closing event 1202. Arming, via said local application 806, said one or more magnetic receiver assemblies 108 to secure said door assembly 104 in said closed configuration 116. Starting, by said local application 806, said timeout clock 1108 to count down to an automatic release of said door assembly 104 from said closed configuration 116. Overriding, upon said local application 806 receiving an override command, said timeout clock 1108 for an extended lockdown period. Concluding the lockdown sequence by disengaging said one or more magnetic receiver assemblies 108 to transition said door assembly 104 to said open configuration 114 in response to an all-clear signal or upon elapse of said timeout clock 1108. Wherein said reinforced door assembly 100 can be installed on a wall within a protected room and can be configured to selectively barricade said doorway 300 when in said closed configuration 116, and wherein said door control panel 200 installed behind said door assembly 104 facilitates the input of the override command and the receipt of the all-clear signal.

Initiating these steps using said local application 806 executed in said one or more processors 802 of said reinforced door assembly 100: detecting a transition of said door assembly 104 to said closed configuration 116, setting a digital condition corresponding to the closed configuration of said door assembly 104, activating said one or more magnetic receiver assemblies 108 to maintain said door assembly 104 in said closed configuration 116, dispatching a notification to a list of authorized parties regarding the status of said door assembly 104, initiating said timeout clock 1108 to prevent a permanent lockdown state of said door assembly 104, and receiving an all-clear signal to transition said door assembly 104 from said closed configuration 116 to said open configuration 114.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A reinforced door assembly for selectively barricading a doorway of a protected room, wherein:
said reinforced door assembly comprises one or more track assemblies, a door assembly, one or more track wheel assemblies, one or more magnetic receiver assemblies on a stopper assembly, and one or more ferromagnetic plates;
said reinforced door assembly is installed on a wall within a protected room, such as a school classroom;
said one or more track assemblies is aligned with and partially surrounds said doorway;
said door assembly is configured to selectively slide between an open configuration and a closed configuration along said one or more track assemblies;
said open configuration comprises said door assembly not blocking said doorway;
said closed configuration comprises barricading said doorway with said door assembly;
said one or more track assemblies comprises at least an upper track assembly;
said door assembly slidably attach to said upper track assembly using said one or more track wheel assemblies;
said one or more track wheel assemblies hang down from and selectively slide within said upper track assembly;
a top portion of said door assembly attach to said one or more track wheel assemblies;
with said reinforced door assembly in said closed configuration, said one or more magnetic receiver assemblies and said one or more ferromagnetic plates attached to one another;
said one or more magnetic receiver assemblies comprises a 1200-pound magnet, providing a secure hold when the door is in the closed position;
said reinforced door assembly comprises a structural frame; and
said door assembly is constructed from ⅜-inch thick AR500 steel, chosen for its ballistic resistance properties, providing robust protection against projectiles.

2. A reinforced door assembly for selectively barricading a doorway of a protected room, wherein:
said reinforced door assembly comprises one or more track assemblies, a door assembly, one or more track wheel assemblies, one or more magnetic receiver assemblies on a stopper assembly, and one or more ferromagnetic plates;
said reinforced door assembly is installed on a wall within a protected room, such as a school classroom;
said one or more track assemblies is aligned with and partially surrounds said doorway;
said door assembly is configured to selectively slide between an open configuration and a closed configuration along said one or more track assemblies;
said open configuration comprises said door assembly not blocking said doorway;
said closed configuration comprises barricading said doorway with said door assembly.

3. The reinforced door assembly of claim 2, wherein:
said reinforced door assembly can further comprise A whiteboard insert.

4. The reinforced door assembly of claim 2, wherein:
when in said closed configuration, said door assembly is designed to overlap the surrounding walls by A wall overlap.

5. The reinforced door assembly of claim 4, wherein:
said wall overlap comprises at least 4 inches on three sides, providing additional protective measures by trapping any projectiles between the door and the wall.

6. The reinforced door assembly of claim 2, wherein:
said one or more track assemblies comprises at least An upper track assembly;
said door assembly slidably attach to said upper track assembly using said one or more track wheel assemblies;
said one or more track wheel assemblies hang down from and selectively slide within said upper track assembly; and
a top portion of said door assembly attach to said one or more track wheel assemblies.

7. The reinforced door assembly of claim 2, wherein:
with said reinforced door assembly in said closed configuration, said one or more magnetic receiver assemblies and said one or more ferromagnetic plates attached to one another; and
said one or more magnetic receiver assemblies comprises a 1200-pound magnet, providing a secure hold when the door is in the closed position.

8. The reinforced door assembly of claim 2, wherein:
said reinforced door assembly further comprises A structural frame; and
said door assembly is constructed from ⅜-inch thick AR500 steel, chosen for its ballistic resistance properties, providing robust protection against projectiles.

9. The reinforced door assembly of claim 2, wherein:
said reinforced door assembly further comprises A door control panel;
said door control panel is installed behind said door assembly with said door assembly in said open configuration;
said reinforced door assembly comprises a door controller assembly having one or more processors, a memory unit, a local application, and a communication unit; wherein,
said reinforced door assembly is configured for initiating on said local application, running on said one or more processors the following steps:
initiating a lockdown sequence upon detecting a door closing event,
arming said one or more magnetic receiver assemblies to secure said door assembly in said closed configuration,
starting a timeout clock to count down to an automatic unlocking of said door assembly,
overriding upon receiving an override command, said timeout clock for an extended lockdown period, and
concluding the lockdown sequence by unlocking said one or more magnetic receiver assemblies in response to an all-clear signal or the lapsation of said timeout clock; and
said door control panel comprises An input switch, and a wireless key reader, a video camera creating a video stream in certain events, as discussed below, and an intercom.

10. The reinforced door assembly of claim 2, wherein:
said reinforced door assembly further comprising A battery backup system which is configured to ensure functionality during power outages; and
said battery backup system configured to provide between five to seven hours of autonomous operation, thereby maintaining security protocols even in the event of an emergency that compromises the power supply.

11. The reinforced door assembly of claim 2, wherein:
said one or more magnetic receiver assemblies is controlled electronically, and access is granted through a key, such as a fire key or electronic identity verification.

12. The reinforced door assembly of claim 2, wherein:
said reinforced door assembly comprises A first door assembly among a plurality of door assemblies;
said plurality of door assemblies are connected to a network and managed by a server application on a server;
said server application is configured to facilitate a safety plan using said reinforced door assembly;
each among said plurality of door assemblies and said server comprises said one or more processors, said memory unit and said communication unit;
said server comprises said server application in said memory unit of said server;
each among said plurality of door assemblies and said server communicate using said communication unit for that computer, respectively; and
said server application executed on said one or more processors of said server, wherein said server application is configured for:
monitoring said plurality of door assemblies connected to said network;
determining the status of each among said plurality of door assemblies as open or closed;
activating said video camera corresponding to the closed door assembly for real-time monitoring;
receiving one of an escalation command, an all-clear command, and a review command;
executing based on the received command, one of a lockdown procedure, a status notification procedure, and an unlock procedure for said plurality of door assemblies.

13. The reinforced door assembly of claim 12, wherein:
said server application in conjunction with said local application of said plurality of door assemblies are configured to monitor a status of said plurality of door assemblies.

14. The reinforced door assembly of claim 2, wherein:
said reinforced door assembly comprises A lower c-channel, a lower square tubing and said one or more lower support wheel assemblies;
said reinforced door assembly comprises An unhinged portion and said hinged portion configured to selectively rotate relative to one another about a hinge axis; and
said hinged portion is secured to said unhinged portion using said tether.

15. The reinforced door assembly of claim 14, wherein:
said hinged portion comprises said lower c-channel, said one or more track wheel assemblies, said doorway blocking portion, and said one or more lower support wheel assemblies; and
said lowered configuration comprises said one or more horizontal reinforcement elements, said leading side portion, said trailing side portion, and said handle.

16. The reinforced door assembly of claim 14, wherein:
said hinged portion is further secured by using fasteners such as bolts to hold said hinged portion against said unhinged portion.

17. The reinforced door assembly of claim 14, wherein:
said lower hinge assembly is configured to selectively rotate about said hinge axis to allow said hinged portion to rotate relative to said unhinged portion; and
said lower hinge assembly is attached to a portion of said lower c-channel and said lower square tubing.

18. A method of use for managing security in a protected room using a reinforced door assembly, the method comprising:
executing, on one or more processors, a local application configured to control said reinforced door assembly;
initiating a lockdown sequence upon said one or more processors detecting a door closing event;
arming, via said local application, one or more magnetic receiver assemblies to secure a door assembly in a closed configuration;
starting, by said local application, a timeout clock to count down to an automatic release of said door assembly from said closed configuration;
overriding, upon said local application receiving an override command, said timeout clock for an extended lockdown period;
concluding the lockdown sequence by disengaging said one or more magnetic receiver assemblies to transition said door assembly to an open configuration in response to an all-clear signal or upon elapse of said timeout clock;
wherein said reinforced door assembly is installed on a wall within a protected room and is configured to selectively barricade a doorway when in said closed configuration, and
wherein a door control panel installed behind said door assembly facilitates the input of the override command and the receipt of the all-clear signal.

19. The method of use of claim 18, further comprising:
initiating these steps using said local application executed in said one or more processors of said reinforced door assembly:
detecting a transition of said door assembly to said closed configuration,
setting a digital condition corresponding to the closed configuration of said door assembly,
activating said one or more magnetic receiver assemblies to maintain said door assembly in said closed configuration,
dispatching a notification to a list of authorized parties regarding the status of said door assembly,
initiating said timeout clock to prevent a permanent lockdown state of said door assembly, and
receiving an all-clear signal to transition said door assembly from said closed configuration to said open configuration.

20. The method of use of claim 18, further comprising:
A server application executed on said one or more processors of a server, wherein said server application is configured for:
monitoring a plurality of door assemblies connected to a network,
determining the status of each among said plurality of door assemblies as open or closed,
activating a video camera corresponding to the closed door assembly for real-time monitoring,
receiving one of an escalation command, an all-clear command, and a review command, and
executing based on the received command, one of a lockdown procedure, a status notification procedure, and an unlock procedure for said plurality of door assemblies;
further wherein,
said reinforced door assembly comprises a first door assembly among said plurality of door assemblies;
said plurality of door assemblies are connected to said network and managed by said server application on said server;
said server application is configured to facilitate a safety plan using said reinforced door assembly;
each among said plurality of door assemblies and said server comprises said one or more processors, a memory unit and a communication unit;
said server comprises said server application in said memory unit of said server;
each among said plurality of door assemblies and said server communicate using said communication unit for that computer, respectively; and
said server application in conjunction with said local application of said plurality of door assemblies are configured to monitor a status of said plurality of door assemblies.
